(19) United States
(12) Patent Application Publication
(10) Pub. No.: US 2009/0212463 A1
(43) Pub. Date: Aug. 27, 2009

(54) APPARATUS FOR RECOVERING AND MOULDING STONES AND ORNAMENTAL ROCKS

(75) Inventor: Paulo Jorge Cardoso Machado, Sta Maria Avioso Maia (PT)

Correspondence Address: SUGHRUE MION, PLLC, 2100 PENNSYLVANIA AVENUE, N.W., SUITE 800, WASHINGTON, DC, 20037, US

(73) Assignee: D2 TECHNOLOGY, LDA., Avioso (Santa Maria) Maia (PT)

(21) Appl. No.: 12/194,363

(22) Filed: Aug. 19, 2008

(30) Foreign Application Priority Data
Feb. 22, 2008 (PT) 103976

(51) Int. Cl. B28B 7/16; B28B 3/00

(52) U.S. Cl. 264/320; 425/235

(57) ABSTRACT

The present invention concerns an apparatus for recovering and moulding stones and ornamental rocks. It comprises the following components:
a) a base structure (10) that works as a housing for both hydraulic and electrical systems and as a base for the inferior mould (5);
b) an inferior base (12), placed over the upper exterior side of the base structure (10), that works as a base for the inferior mould (5);
c) a guide structure (2) connecting the inferior base (12) to an upper base (11) placed in the top and fixed to the base structure (10);
d) a hydraulic cylinder (3) vertically placed at the centre of the upper base (11);
e) a coupled upper mould (4) comprising cutting blades (14), embodied in the cylinder (3), which defines the shape of the product;
f) an inferior mould (5) placed on the inferior base (12), which is similar to the upper mould (4).

The present invention is useful to transform stones, stone residue and ornamental rocks in pieces that can be used in construction as a revetment or a cover.

### TECHNICAL FIELD

The present invention concerns an apparatus for recovering and moulding stones and ornamental rocks such as marble, granite, limestone and/or stone agglomerate. The present invention is useful to transform stone residue, stones and ornamental rocks in agglomerate structures that can be for example recovered in the revetment manufacture in civil construction.

### SUMMARY OF THE INVENTION

The apparatus according to the present invention has been conceived to create moulds in marble, granite, limestone or stone agglomerates by means of cutting through pressure.

The present invention's purpose to transform slabs made of marble, granite, or agglomerates thereof, in shapes such as hexagons, squares, rectangles, triangles, circles, curves, that is, any kind of shape intended to execute.

The present invention is useful to transform rock patterns into shapes that are different from the ones until then existent, taken that in order to recreate the shapes obtained by this machine would only be possible with more expensive and slow apparatuses. For example, to create a square of 10×10 cm, which is a simple shape, this could be carried out with an electrical cutting machine using a diamond blade, such requiring from the technician at least 10 minutes to produce a piece and the tooling cost would rise up to 200% more than the effective cost provided by the present invention, and yet the execution time using the present invention would be in great advantage because in would only take 10 seconds to obtain a piece. In the case of a mould with a curved shape, size 200 cm×150 cm, the execution time, using the same kind of machine and tool, would be of 30 minutes, while with our invention it would take the same 10 seconds. If we eventually used a water jet numerical control machine, the processing time would probably reduce to 10 minutes, in the case of the 200 cm×150 cm mould, but the costs of such a machine is about 150 000 ε, meaning high investment for low profitability. One of the great advantages is that small leftovers of stone can be recovered which would usually be rejected and considered as waste. By means of this recovery, a wide range of pavements can be obtained.

Tests were carried out in all kinds of natural stones and agglomerates thereof and all results obtained therefrom were of 100%. The tests were considered 100% successful because all kinds of material used fulfilled all the criteria (cutting time and cutting quality). The tests were carried out using different kinds of material (limestone, granite, marble and agglomerates thereof), considering the following criteria:
cutting time;
cutting quality per material category;
wear and strength of cutting blades.

### BACKGROUND OF THE INVENTION

Similar apparatus to the present invention are the machines cube moulding for sidewalks or breaking stone for fronts. Both operate hydraulically, like a hydraulic press, but their functionality and final results have however nothing to do with the one herein presented, as none of them allows creating curved straight or other profiles, nor moulding simultaneously a certain quantity of stones and ornamental rocks. Besides, the apparatus of the present invention allows one or more simultaneous mouldings, such as a 10 cm×10 cm square with a cube moulding machine.

Apparatuses with similar operation, currently available in the market, can only create linear cuts, being therefore limited in two very important aspects. One aspect concerns the obtainable geometric shapes (curved shapes are not obtainable), the other aspect concerns the number of steps required to obtain a finished piece (for example, four steps are required to obtain a cube). With the present invention it is now possible to obtain straight or curved shapes in one single step. This allows obtaining a significantly higher amount of finished pieces within the same period of time. The fact that curved pieces can be obtained in just one step is innovative, because current methods would require several time-consuming manual operations or sophisticated and expensive apparatus to obtain this kind of pieces.

In current machines the technician must turn the piece 4 times to execute 4 cuts, then, between each cut the operator must have a screed or must measure in order to obtain a correct dimension. Therefore, in these operations he will spend at least 5 minutes. Then, the cut will not be as perfect because the blade capacity and shape does not allow so. But, with this machine, we manage to cut for example shapes such as a square, a triangle, a rectangle or straight forms, or even curved shapes.

Regarding known documents that disclose stone moulding machines, among those existent, none comes close to the present invention. For example, the document U.S. Pat. No. 4,046,325 discloses a device that turns bigger stone pieces into smaller pieces but without a final definite shape (production of gravel), while the present invention has the advantage of moulding the objects' final shape.

As for document US 20070245682 the recovery of small portions of rock is disclosed, but through the mixture of the remaining portions with a binder and subsequent shaping, while the present invention advantageously acquits the use of a binder.

Therefore, none of both analyzed documents approaches the presented invention, being important to highlight that the present invention allows curved cuts, unlike machines known in the state of the Art.

### GENERAL DESCRIPTION OF THE INVENTION

The ground for the development of this invention was to create something that could somehow reuse the small parts of marble, granite, limestone or agglomerates thereof and somehow recycle them or transform them into something that could be anon sold.

Obviously this invention aims not only waste, but also new plates. However, since nowadays there is a significant setback for factories to get rid of the waste resulting from plate transformation made of marble, granite, limestone or agglomerates thereof, the present invention is aimed to such a purpose. It is obvious that waste is somehow abundant, but mostly not as abundant as to invest in a highly expensive machine, such as water jet cutting machine, which has an average cost of 150 000ε, and with which the final cost of material would certainly become non marketable due to its high value per m2.

The present invention concerns an apparatus for recovering and moulding stone and ornamental rocks, comprising the following components:
a. a base structure (10) that works as a housing for both hydraulic and electrical systems and as a base for the inferior mould (5);
b. an inferior base (12), placed over the said upper exterior side of the base structure (10), that works as a base for the fixing of the inferior mould (5);
c. a guide structure (2) connecting the said inferior base (12) to a base (11) placed in the upper part and which is vertically fixed to the base structure (10);
d. a hydraulic cylinder (3) vertically placed at the centre of the upper base (11);
e. a coupled upper mould (4) comprising cutting blades (14), embodied in the cylinder (3), which defines the shape of the product;
f. an inferior mould (5) placed on the inferior base (12), which is similar to the said upper mould (4).

The moulds consist of two parts: inferior part (5) and upper part (4), both carrying blades (14) which are highly resistant against shock and wear.

Therefore, the mould consists of by two parts, a upper (4) and an inferior part (5). Both the upper (4) and the inferior parts (5) are made of two rectified steel bases (11, 12) being one of the bases tightly coupled to the machine (12), the other base (11) having the blades (14) assembled by means of sockets according to the mould type.

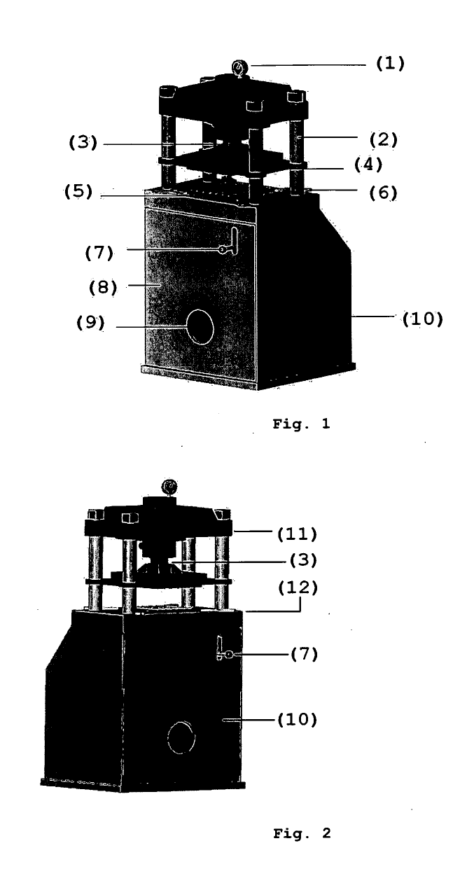

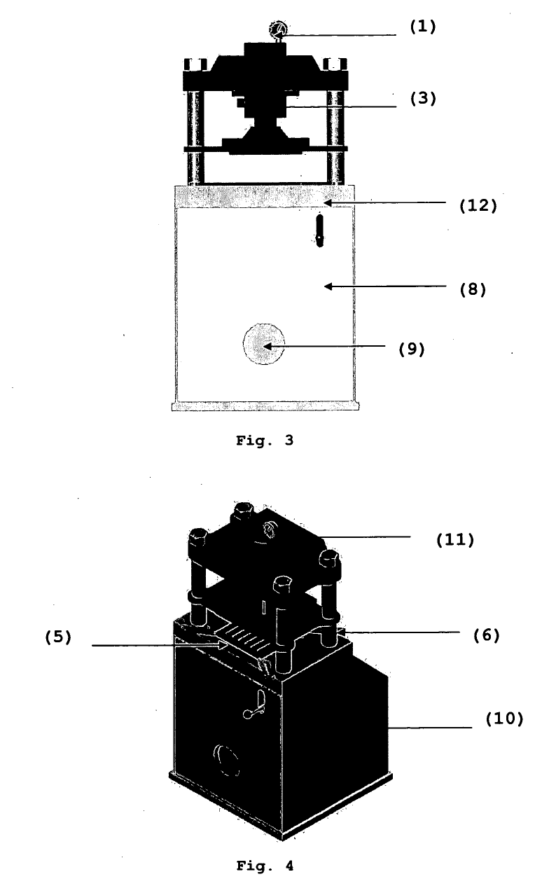

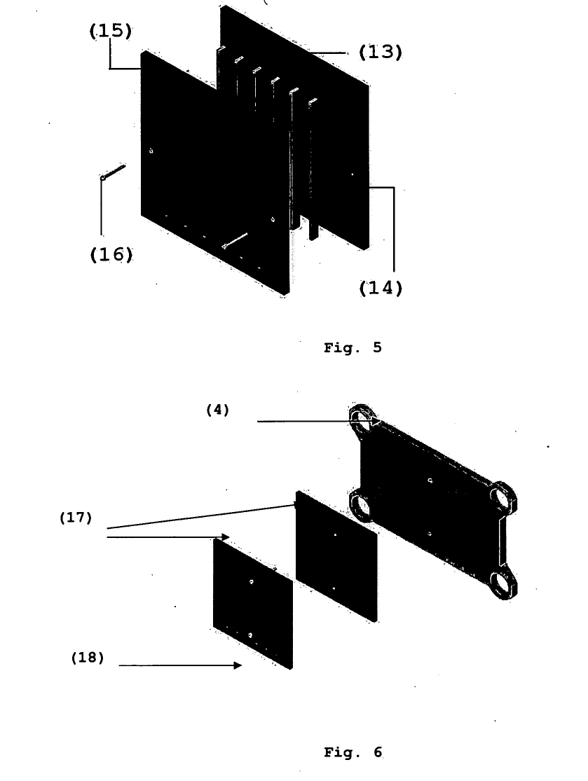

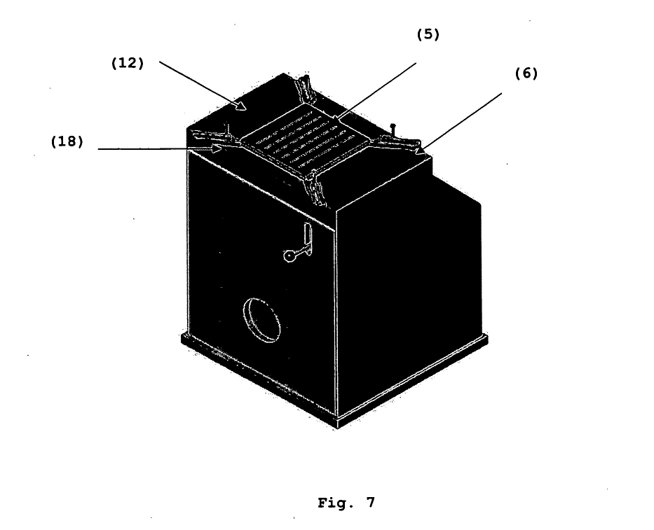

This invention consists of a hydraulic machine that works as a press, but in which blades (14) with several shapes are applied, and, given their technical features, the invention gives way to cutting through pressure, hard material such as granite, marble, limestone or agglomerates thereof. The blades (14) are encased in a mould that is torn according to the desired final shape. Behind the torn part (15), a plate with the same dimensions is screwed so that the blades can be held (14), as shown in FIG. 5. The moulds (4, 5) are assembled in the machine such as to allow its fast replacement.

### BRIEF DESCRIPTION OF THE IMAGES

Image 1: Schematic representation of a perspective view of the apparatus, the pressure manometer (1), sliding guide or cylindrical columns (2), hydraulic cylinder (3), upper support of the mould (4), inferior part of the mould (5), mould fixing device (6), the machine's actuating lever (7), machine door (8), placement of the cooling system (9) and the base structure of the machine (10) being indicated.

Image 2: Schematic representation of a perspective view of the apparatus, the hydraulic cylinder (3), actuating lever (7), base structure of the machine (10), upper base made of solid steel (11) and inferior base made of solid steel (12) being indicated.

Image 3: Schematic representation of a perspective view of the apparatus, the pressure manometer (1), hydraulic cylinder (3), inferior base made of solid steel (12), machine door (8) and placement of the cooling system (9) being indicated.

Image 4: Schematic representation of a perspective view of the apparatus, the upper base made of solid steel (11), the mould fixing device (6), the inferior part of the mould (5) and the machine base structure (10) being visible.

Image 5: Example of how the blades are assembled in a mould, wherein the blade support base (13), a blade (14), the torn base (15) and a plate fixing screw (16) are indicated.

Image 6: Fixing mode of the upper part of the mould (17) to the upper support of the mould (4), by means of screws (18).

Image 7: fixing mode of the inferior part of the mould (5) to the inferior base (12), by means of fixing devices (6), screws (18) being also indicated.

### EMBODIMENT

A construction example will be hereinafter described for actuating and operating an apparatus for moulding and recovering stone and ornamental rocks:

a base structure (10) that works simultaneously as a housing for both hydraulic and electrical systems;

a conveniently-rectified inferior base—base in hard steel (12), is placed over the upper exterior part of the base structure (10);

from the same upper exterior part, four cylindrical columns (2) are projected, which can be made of 60 mm-wide stainless steel and which must be placed vertically on the four corners of the inferior base (12), thus connecting with a stainless steel base placed on the upper part (11);

In the middle of the upper base (11) is a hydraulic cylinder vertically placed, which will move upwards and downwards continuously guided by the cylindrical stainless steel columns (2);

The cylinder (3) has a mould (4) coupled to the cutting blades (14);

The cylinder (3) exerts load up to 20 tons and moves to the inferior base (12) where it also houses a mould (5) presenting the same size of the one above-placed.

Structure of the Apparatus

The apparatus for recovering and moulding stone and ornamental rocks is composed by a base made, of a 8 mm-thick bent metal plate, an inferior base made of 80 mm thick steel (12), a 120 mm-thick upper base (11) and four stainless steel columns (2) each being 60 mm thick.

Mechanical Actuation

The mechanical actuation is made through a hydraulic pump capable of a 20-ton load, and a hydraulic cylinder (3).

Electric System

The electric system consists of a 5.5 kW motor, supplied at 380 V, a cooling fan (9) for the purpose of cooling the hydraulic pump, a circuit breaker, pump actuating knobs and an emergency button.

Moulds

The moulds consist of two parts, the upper part (4) and the inferior part (5). Each part has two rectified plane bases (base 11 and base 12), which have laser-made cuts where the blades enter (14).

Moulding Process

Connecting the machine to power supply by means of a 4 pin triphasic plug.

Actuating the hydraulic pump on the adequate command (7).

Placement of a flat stone between the inferior mould (5) and upper mould (4).

Pushing the lever (7) which is connected to the hydraulic device making the hydraulic cylinder move downwards (3) and moving the upper part of the mould (4) towards the stone.

By exerting a 20-ton load, resulting from the highly effective blades (14) the cylinder (3) cuts the stone with into the desired shape.

1. Apparatus for recovering and moulding stones and ornamental rocks, comprising the following components:
a. a base structure (10) that works as a housing for both hydraulic and electrical systems and as a base for the inferior mould (5);
b. an inferior base (12), placed over the said upper exterior side of the said base structure (10), that works as a base for the fixing of the inferior mould (5);
c. a guide structure (2) vertically fixed to the base structure (10) connecting the said inferior base (12) to a base (11) placed in the upper part;
d. a hydraulic cylinder (3) vertically placed at the centre of the upper base (11);
e. a coupled upper mould (4) comprising cutting blades (14), embodied in the cylinder (3), which defines the shape of the product;
f. an inferior mould (5) placed on the inferior base (12), which is similar to the said upper mould (4).

2. Apparatus for recovering and moulding stones and ornamental rocks, according to claim 1, characterized in that the guide structure (2) that guides the two bases (11, 12) is composed of four cylindrical columns (2), that pass through the said base (12), which must be placed vertically and in the four corners of the base structure (10), connecting it to the upper base (11).

3. Apparatus for recovering and moulding stones and ornamental rocks, according to claim 2, characterized in that the four cylindrical columns (2) are made in solid stainless steel.

4. Apparatus for recovering and moulding stones and ornamental rocks, according to claim 2, characterized in that the four cylindrical columns (2) is 60 mm thick.

5. Apparatus for recovering and moulding stones and ornamental rocks, according to claim 2, characterized in that both bases (11, 12) are made of solid stainless steel.

6. Apparatus for recovering and moulding stones and ornamental rocks, according to claim 2, characterized in that the upper base (11) is 120 mm thick.

7. Apparatus for recovering and moulding stones and ornamental rocks, according to claim 2, characterized in that the inferior base (12) is 80 mm thick.

8. Method for recovering and moulding stones and ornamental rocks, according to the previous claims, comprising the following steps:
a) Connecting the machine to power supply;
b) Actuating the hydraulic pump on the command (7);
c) Placing of a flat stone between the inferior (5) and upper mould (4).
d) Pushing the lever (7) in order to make the hydraulic cylinder move downwards (3) thus moving the upper mould (4) towards the stone.
e) due to its blades (14), the cylinder (3) cuts the stone;
f) the stone is pressed between the moulds (4, 5) until it obtains the desired shape.
